(19) United States
(12) Patent Application Publication
(10) Pub. No.: US 2026/0330921 A1
(43) Pub. Date: Oct. 22, 2026

(54) TRANSFER LIMITS ON REDEEMING TICKET VOUCHERS TO EXTERNAL FUNDING DESTINATIONS

(71) Applicant: IGT, Las Vegas, NV (US)

(72) Inventors: Kevin Higgins, Reno, NV (US); Jeffery Shepherd, Reno, NV (US)

(21) Appl. No.: 19/186,104

(22) Filed: Apr. 22, 2025

(51) Int. Cl. G07F 17/32; G06Q 20/10; G06Q 20/40

(52) U.S. Cl. CPC G07F 17/3237; G06Q 20/108; G06Q 20/4016; G07F 17/3241

(57) ABSTRACT

Systems and methods that, responsive to a redemption of a ticker voucher associated with a request to transfer an amount of the ticket voucher to a financial institution account associated with a user, determine if the redemption of the ticket voucher complies with a transfer limit. Responsive to the determination being that the redemption of the ticket voucher complies with the transfer limit, the systems and methods cause the amount of funds associated with the ticket voucher to be transferred to the financial institution account. Responsive to the determination being that the redemption of the ticket voucher does not comply with the transfer limit, the systems and methods disable the amount of funds associated with the ticket voucher from being transferred to the financial institution account.

### BACKGROUND

When a player cashes out a credit balance of a gaming machine, such as an electronic gaming machine, the gaming machine may provide the player with a cashless ticket voucher redeemable for the amount of the credit balance.

### BRIEF DESCRIPTION OF THE SEVERAL VIEWS OF THE DRAWINGS

FIG. 1A is an example configuration of the architecture of a plurality of different components of certain embodiments of the system of the present disclosure.

FIG. 1B is an example configuration of the architecture of a plurality of different components of certain embodiments of the system of the present disclosure.

FIG. 2A is an example flowchart of an example process for operating a system that enables funds associated with a redeemed ticket voucher to be transferred to a financial institution account from an electronic gaming machine.

FIG. 2B is an example flowchart of an example process for operating a system that enables funds associated with a redeemed ticket voucher to be transferred to an escrow account and then to a financial institution account.

FIG. 3A is a flow chart of the lifecycle of a ticket voucher prior to the system of the present disclosure.

FIG. 3B is a flow chart of the lifecycle of a ticket voucher afforded by the system of the present disclosure.

FIG. 4 is an example flowchart of an example process for operating a system that employs a component of an anti-money laundering system in association with potentially enabling funds associated with a redeemed ticket voucher to be transferred to a financial institution account.

### DETAILED DESCRIPTION

In various embodiments, responsive to a redemption of a ticker voucher associated with a request to transfer an amount of the ticket voucher to a financial institution account associated with a user, the systems and methods of the present disclosure determine if the redemption of the ticket voucher complies with a transfer limit. In these embodiments, responsive to the determination being that the redemption of the ticket voucher complies with the transfer limit, the systems and methods cause the amount of funds associated with the ticket voucher to be transferred to the financial institution account. In these embodiments, responsive to the determination being that the redemption of the ticket voucher does not comply with the transfer limit, the systems and methods disable the amount of funds associated with the ticket voucher from being transferred to the financial institution account.

In certain embodiments, following a user procuring a ticket voucher (e.g., an anonymous bearer instrument associated with an amount of funds), the system enables the user to employ a gaming establishment device configured to handle ticket vouchers, such as an electronic gaming machine (“EGM”) or a ticket voucher redemption kiosk, to redeem the ticket voucher in association with a transfer of the associated amount of funds to a financial institution account that is associated with the user and maintained independent of the system (i.e., an external account). In these embodiments, utilizing a mobile device to receive authentication information associated with the financial institution account, various distinct and independently operating computing components (e.g., a gaming establishment device, a mobile device, a ticket voucher system, and a gaming establishment fund management system) operate together to cause a transfer of the amount of funds associated with the redeemed ticket voucher to the financial institution account. For example, a user with a ticket voucher interacts with an externally controlled user interface displayed by an EGM (i.e., a service window) to indicate that they want to redeem their ticket voucher to a financial institution account, such as a bank account. In this example, following the presentation of a generated QR code (which the user scans with their mobile device) and the user entering certain information associated with the ticket voucher and/or the financial institution account, the EGM (and/or the mobile device) prompts the user to insert the ticket voucher into the EGM. If the received ticket voucher of this example is validated by a ticket voucher system operating with the EGM, rather than communicating any fund data associated with an amount of credits of the redeemed ticket voucher to be added to a credit balance of the EGM, the ticket voucher system operates with one or more gaming establishment fund management system components to cause a transfer of the amount of funds associated with the redeemed ticket voucher to the user identified financial institution account.

As illustrated by this example, rather than redeeming a ticket voucher at an EGM, a ticket voucher redemption kiosk or a gaming establishment interface, such as a cashier at a casino desk, for an amount of cash equal to an amount of funds associated with the redeemed ticket voucher, the system of the present disclosure enables a user to redeem a ticket voucher in exchange for an electronic transfer of funds to a financial institution account maintained independent of the system. Such a transfer represents a non-cash redemption of the amount of funds associated with the redeemed ticket voucher becoming available as an increase to a balance of the financial institution account. Moreover, since certain anonymous users (or users identified by a gaming establishment patron management system that have not established a gaming establishment fund management system account, such as a cashless wagering account) have no way of electronically directing funds at a gaming establishment device, such as an EGM, to their external financial institution account, the system of the present disclosure enables such anonymous users (and enables such identified users that lack the requisite gaming establishment accounts to facilitate financial institution account fund transfers) to redeem a ticket voucher at a gaming establishment device and cause an amount of funds of the ticket voucher to be electronically directed to their external financial institution account.

In certain embodiments, to facilitate the redemption of a ticket voucher in association with a financial institution account, the system employs a gaming establishment device that is in communication with a ticket voucher system (that issues and/or redeems ticket vouchers in association with activities undertaken at that gaming establishment device), a mobile device (that enables a user to select an external destination of ticket voucher funds) and a gaming establishment fund management system (that interfaces with one or more external destinations of ticket voucher funds to enable the transfer of funds to such external destinations). Such a gaming establishment device sits at the intersection of a ticket voucher system and a gaming establishment fund management system and interacts with these systems to enable a user the opportunity to redeem a ticket voucher for an amount of funds deposited into a financial institution account, such as a bank account.

In certain embodiments, the ticket voucher system in communication with the gaming establishment device employs certain ticket voucher states to enable the redemption of a ticket voucher for an amount of funds deposited into a financial institution account. In these embodiments, as a mechanism to prevent a ticket voucher being redeemed from automatically being exchanged for an amount of cash (if the gaming establishment device is a ticket voucher redemption kiosk) or an increased balance (if the gaming establishment device is an EGM), the ticket voucher system utilizes one or more additional ticket voucher states (e.g., an awaiting external transfer state, a pending external transfer state and an externally transferred state) to assign to a ticket voucher being redeemed for a transfer of funds to a financial institution account. Such additional ticket voucher states enable proper tracking, reporting and/or troubleshooting of ticket vouchers redeemed for an amount of funds directed to a user selected external destination of ticket voucher funds.

In certain embodiments, in providing an alternative, non-cash-based option for a user to redeem a ticket voucher for a transfer of funds to a financial institution account, the system operates with one or more safeguard systems to ensure that any transfer of funds associated with any ticket vouchers to any external destinations of ticket voucher funds correspond with gaming establishment regulations, financial institution regulations and/or user preferences. In certain such embodiments, the system employs one or more anti-money laundering services to ensure that such transfers comply with various anti-money laundering obligations (e.g., anti-money laundering regulations) which require the tracking of certain financial transactions associated with a gaming establishment patron. In these embodiments, since the ticket vouchers are anonymous instruments and are effectively bearer bonds for the user and the gaming establishment, the system augments one or more external fund transfers with anti-money laundering capabilities. In certain additional or alternative embodiments, the system employs one or more responsible gaming services to enable a user to redeem a ticket voucher for a transfer of funds to a financial institution account while complying with various responsible gaming limitations associated with a user.

It should be appreciated that in addition to potentially providing a relatively more secure environment for a user (via reducing or eliminating a user carrying cash on their person after redeeming a ticket voucher and thus diminishing the risks that such cash may be lost or stolen), the system benefits the gaming establishment by freeing the gaming establishment up from having to maintain relatively large amounts of cash in any cash dispensing ticket voucher redemption kiosks. By reducing the use of such kiosks by enabling users to redeem, from any gaming establishment device (e.g., any EGM or ticket redemption kiosk on a casino floor), their ticket voucher in association with a transfer of funds to an external destination, the system enables gaming establishments to maintain less amounts of cash in these kiosks, reduce wear and tear on these kiosks (thus prolonging the operational life on such kiosks) and may even require fewer cash dispensing ticket voucher redemption kiosks (thus reducing energy consumption by the casino). Moreover, a reduction in cash-based transactions reduces computational resources otherwise dedicated to sorting, counting and processing such cash, leading to energy savings as components tasked with sorting, counting and processing such cash are used less.

Additionally, by reducing the amount of cash transactions in a gaming establishment via redeeming ticket vouchers in association with transfers to external destinations, the system reduces or eliminates human errors which often occur when ticket vouchers are redeemed at gaming establishment interfaces, such as casino desks. Specifically, eliminating gaming establishment personnel from issuing amounts of cash in exchange for redeemed ticket vouchers not only protects the user (if the gaming establishment personnel provides the gaming establishment patron less cash than the patron deserves) but also protects the gaming establishment (if the gaming establishment personnel inadvertently or fraudulently provides the patron more cash than the patron deserves). As such, to further expand the cashless ecosystem certain gaming establishments strive for and since certain gaming establishment patrons are uncomfortable with large amounts of cash in a gaming establishment, the system of the present disclosure realizes various advantages not available from prior systems by enabling a user the opportunity to redeem a ticket voucher for an amount of funds transferred to a financial institution account in which the redemption occurs independent of any amount of cash and relatively more secure than any transaction involving an amount of cash.

In various embodiments, the system of the present disclosure includes or otherwise operates with various sub-systems to enable the redemption of a ticket voucher for a transfer of funds to a financial institution account associated with a user that is independent of any gaming establishment account, such as a cashless wagering account, also associated with the user. In certain such embodiments, to facilitate such a transfer, the system employs a gaming establishment device (e.g., a ticket voucher redemption kiosk, an EGM, or a component of a gaming establishment patron management system associated with the gaming establishment device, such as a slot machine interface board (“SMIB”) associated with an EGM), one or more components of a ticket voucher system, and one or more components of a gaming establishment system that interface with one or more components that maintain the financial institution account.

In certain embodiments, the system includes or is otherwise in communication with one or more components of a gaming establishment fund management system that operate an external funding service. In such embodiments, one or more servers of the external funding service enable for a single entry point for all external funding transactions and if necessary, operate to disambiguate between destination sites of funds transferred to one or more external funding destinations and/or from one or more external funding sources.

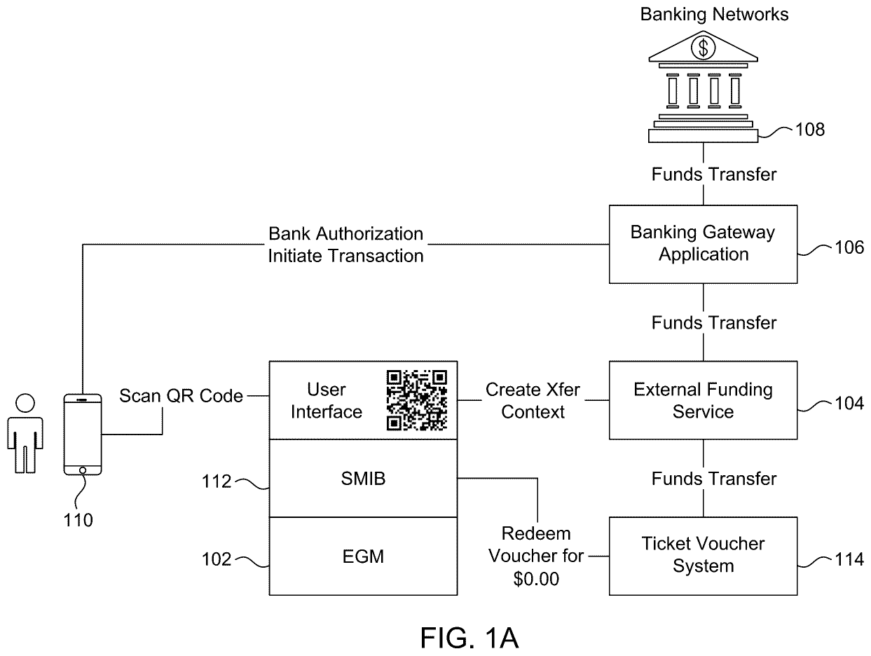

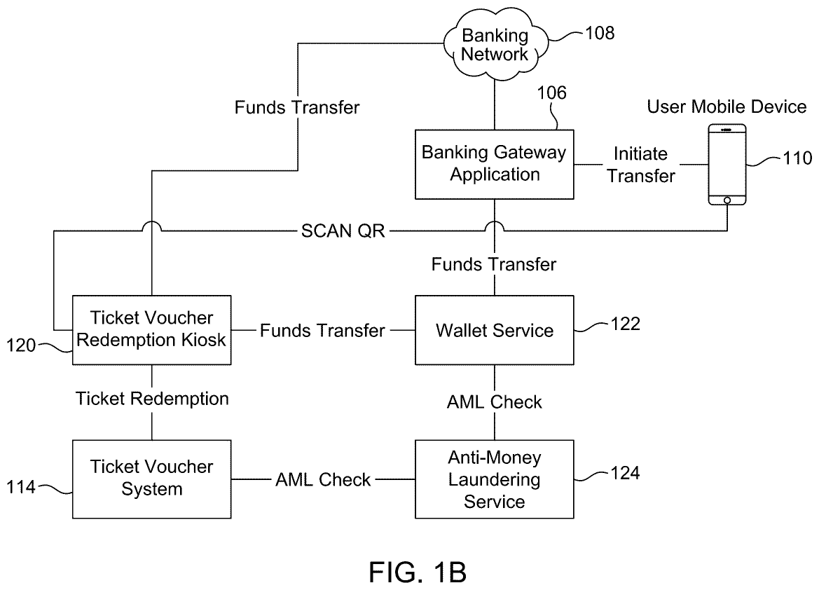

In certain embodiments, the system includes or is otherwise in communication with one or more components of a gaming establishment fund management system that operate a payment gateway. The payment gateway is operable to interface with a banking network to communicate with one or more servers of one or more financial institutions that maintain one or more financial institution accounts and implement zero, one or more financial institution protocols, such as banking protocols. That is, the payment gateway is operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers via ticket voucher redemptions. For example, as seen in FIG. 1A, a gaming establishment device (e.g., EGM 102) is in communication with one or more servers operating an external funding service 104. In this example, the one or more servers operating the external funding service are in communication with one or more servers operating a payment gateway (i.e., banking gateway application 106) which is in communication with a network of one or more banks or other financial institutions (i.e., the banking networks 108) that operate to electronically maintain funds in the user's accounts at such banks or other financial institutions.

In different embodiments, the financial institution accounts which funds associated with one or more ticket vouchers are transferred to include, but are not limited to, one or more checking accounts maintained by one or more financial institutions (e.g., one or more banks and/or credit unions), one or more savings accounts maintained by one or more financial institutions, one or brokerage accounts maintained by one or more financial institutions, one or more credit card accounts maintained by one or more financial institutions, one or more debit card accounts maintained by one or more financial institutions, one or more open-loop pre-paid card accounts maintained by one or more financial institutions, one or more accounts supporting original credit transaction transfers maintained by one or more financial institutions, and/or one or more third-party maintained accounts (e.g., one or more PayPal® accounts or Venmo® accounts). It should be appreciated that any component or sub-system of the present disclosure can be in communication with one or more components of one or more financial institutions.

In various embodiments, the system includes or is otherwise in communication with a ticket voucher system. In these different embodiments, the ticket voucher system includes one or more servers which store, in one or more databases, ticket voucher identification information associated with each ticket voucher created by the ticket voucher system, such as identifying information, and/or value information. For example, as seen in FIG. 1A, a gaming establishment device (i.e., a SMIB 112 supported by EGM 102) is in communication with a ticket voucher system 114.

In certain embodiments, each ticket voucher includes or is otherwise associated with different identifying information which is identifiable to a holder of the ticket voucher, such as a ticket voucher validation number, and an amount of funds associated with the ticket voucher. In different embodiments, the ticket voucher database and/or the ticket voucher includes or is otherwise associated with various fields of ticket voucher identifying information including, but not limited to: (i) a primary key (i.e., an index for a record in a table); (ii) a ticket voucher validation number (i.e., the validation number associated with the issued ticket); (iii) a ticket state (e.g., a state of a ticket as being in an issued state, a pending state, a redeemed state, an awaiting external transfer state, a pending external transfer state and an externally transferred state); (iv) an issuance date/time (i.e., the date/time when the ticket voucher was issued); (v) a property address associated with the ticket voucher issuance; (vi) an amount of funds associated with the ticket voucher; (vii) any expiration date associated with the ticket voucher; (viii) a device identification associated with the issuance of the ticket voucher; (ix) an image of the ticket voucher (e.g., an image of a front of the ticket voucher and/or an image of a back of the ticket voucher); (x) any redemption date (i.e., the date the ticket voucher was redeemed at (if the ticket voucher is in the redeemed state or the externally transferred state)); (xi) redeemed at (i.e., the device where the ticket voucher was redeemed (if the ticket voucher is in the redeemed state or the externally transferred state)); (xii) a data signature (i.e., a signature of the data associated with the ticket voucher to prevent tampering by casino employees); (xiii) a machine identification (i.e., an asset or machine number of the device that printed the ticket voucher); (xiv) any fees imposed based on any external account transfers associated with a redemption of the ticket voucher; and/or (xv) any refunds of any fees imposed based on any external account transfers associated with a redemption of the ticket voucher.

In addition to maintaining information associated with each ticket voucher, in certain embodiments in which the ticket voucher takes the form of a paper ticket voucher, the ticket voucher system includes one or more ticket voucher system components, such as a ticket voucher printer configured to print paper ticket vouchers and/or a ticket voucher acceptor configured to receive paper ticket vouchers. For example, a ticket voucher printer is associated with a gaming establishment device that prints ticket vouchers. In certain other embodiments in which a ticket voucher takes the form of a virtual ticket voucher, the ticket voucher system includes one or more interfaces operable to communicate data associated with a virtual ticket voucher with a mobile device.

In certain embodiments, the system utilizes one mobile device application to interact with the different components of (or in communication with) the system to, amongst other actions, facilitate the redemption of a ticket voucher in association with a transfer of funds to a financial institution account. For example, utilizing the same mobile application, a mobile device interacts with both a SMIB and a component of the ticket voucher system. In certain embodiments, the system utilizes multiple mobile device applications to interact with the different components of (or in communication with) the system to, amongst other actions, facilitate the redemption of a ticket voucher in association with a transfer of funds to a financial institution account. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

In certain embodiments, to interact with one or more components of (or in communication with) the system, the system enables a user to pair or link their mobile device to a gaming establishment device. In these embodiments, the pairing or linkage between the mobile device and the gaming establishment device occurs via one or more applications being run or executed on the mobile device. In certain such embodiments, the mobile device application prompts the user to cause the mobile device to engage the gaming establishment device or a component of a gaming establishment management system supported by the gaming establishment device (e.g., a SMIB of an EGM). After any required engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with a requested action. Following the mobile device application communicating, via a wireless communication protocol, data associated with a requested action, the gaming establishment device (or a component of the gaming establishment device and/or the mobile device application) proceeds with operating with a component of (or in communication with) the system to request authorization of the requested action.

In different embodiments, in addition to or alternatively from utilizing a mobile device running a mobile device application to facilitate the completion of one or more actions, such as the redemption of a ticket voucher in association with a transfer of funds to a financial institution account, the system utilizes a gaming establishment device (e.g., a ticket voucher redemption kiosk, an interface of an EGM or an interface of a gaming table component), an externally controlled user interface (i.e., a service window) displayed by the gaming establishment device, a component of a gaming establishment patron management system, such as a player tracking unit, and/or a gaming establishment interface, such as a casino desk to facilitate the completion of one or more actions. It should be appreciated that while illustrated in at least FIG. 1A as using a mobile device 110 running a mobile device application to enable a user access to the system, in other embodiments, a physical instrument, such as a smart card or a user issued magnetic striped card may additionally or alternatively be utilized to enable a user such access. It should also be appreciated that two or more of the systems, sub-systems and components of the present disclosure may be combined into a single system, sub-system or component operable to accomplish the various tasks each of such separate components are described as accomplishing individually.

In various embodiments, following a user obtaining one or more ticket vouchers, such as upon a user of an EGM cashing out a credit balance in exchange for a ticket voucher associated with an amount of funds of the cashed out credit balance, the system enables a user to redeem the ticket voucher in exchange for a non-cash form of payment including a transfer of the amount of funds associated with the ticket voucher to a financial institution account. In certain embodiments, following a user deciding they want to cash their ticket voucher out to a financial institution account, the user interfaces with the gaming establishment device to indicate that they want to cash their ticket voucher out to a financial institution account. For example, as seen in FIG. 1A, the user interfaces with a user interface displayed by EGM 102 to select a transfer ticket voucher option to redeem a ticket voucher for a transfer of funds to a financial institution account maintained independent of any gaming establishment account.

In certain embodiments, following a user deciding they want to cash their ticket voucher out to a financial institution account, prior to inserting a ticket voucher at a gaming establishment device capable of handling the redemption of ticket vouchers (e.g., an EGM, a gaming table component or a ticket voucher redemption kiosk), the user interfaces with the gaming establishment device to indicate that they want to cash their ticket voucher out to a financial institution account. In these embodiments, since the gaming establishment device may have a timeout for ticket voucher redemption in which if the ticket voucher to be redeemed is not validated by a ticket voucher system within a predefined amount of time, the gaming establishment device assumes the ticket voucher system is offline and returns the ticket voucher to the user, having the user set up the transfer to the financial institution account prior to inserting the ticket voucher to be redeemed reduces instances of this timeout being reached.

In certain embodiments, following the user selecting to redeem a ticket voucher in association with a financial institution account (and thus bypassing a redemption of the ticket voucher to increase a balance of the gaming establishment device), the system presents machine-readable indicia, such as a QR code, to the user to scan. In certain instances, the system requests a nonce from a back-end service to construct a QR code unique to the gaming establishment device. The QR code represents a uniform resource locator (“URL”) that directs the user to a website landing page (or other interface) associated with an identification of the gaming establishment device and a nonce value associated with the QR code. In certain embodiments, URL contains or is otherwise associated with additional information, such as a transaction identifier (that enables the payment gateway to identify the funds to be transferred from the ticket voucher system), the amount of the ticket voucher, a date and time of the requested transaction, a gaming establishment identifier, and/or a gaming establishment location.

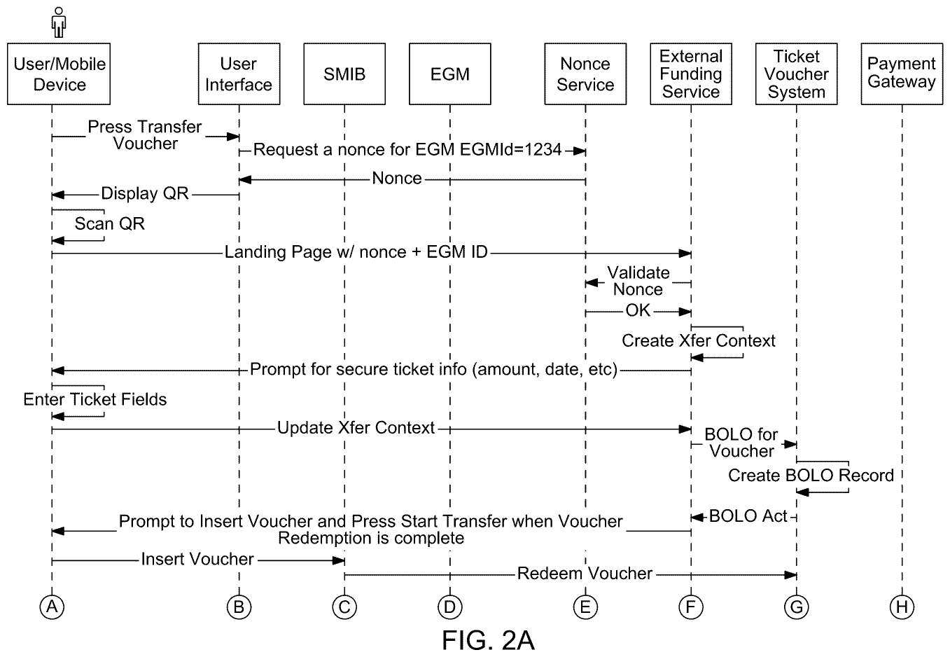

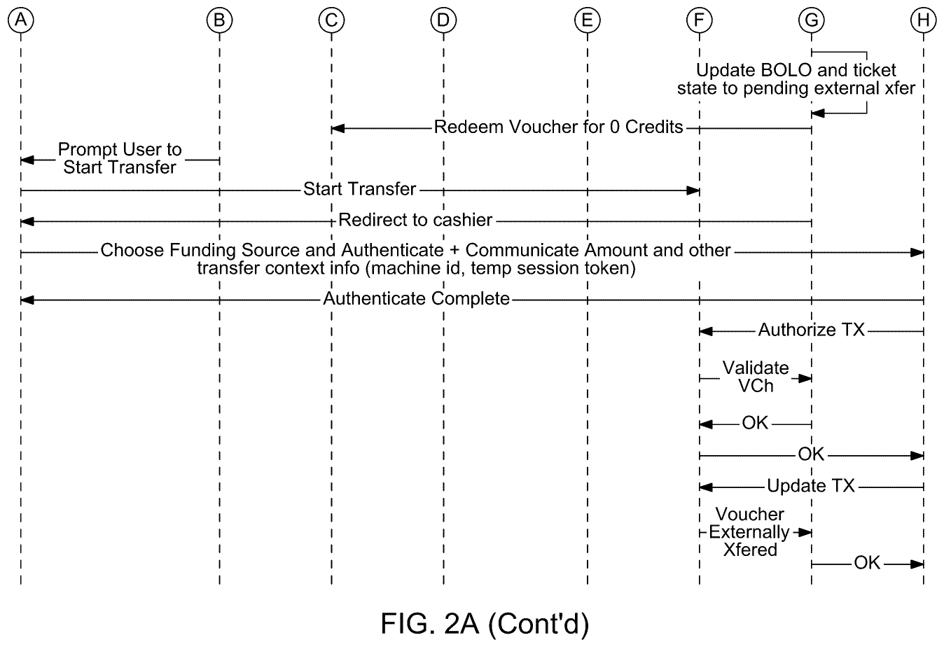

In operation of certain embodiments, the user navigates to the website landing page where one or more components validate the nonce that was issued and create transfer context data for the transfer of funds associated with the ticket voucher to a financial institution account associated with the user. At the website landing page, the user is prompted to enter certain information associated with the ticket voucher, such as entering the amount of funds associated with the ticket voucher, to enable the system to identify the ticket voucher to be redeemed prior to that ticket voucher being received by a gaming establishment device. For example, as seen in FIG. 2A (which illustrates the different interactions between a user with a mobile device, an EGM with an associated SMIB, a user interface displayed by the EGM, a nonce service, a component that operates an external funding service, a component of a ticket voucher system, and a component that executes a payment gateway), following a user interfacing with the user interface displayed by an EGM to indicate they want to redeem a ticket voucher in association with a transfer of funds to a financial institution account, the component controlling the user interface operates with the nonce service to cause the display, by the user interface, of a QR code associated with an identifier of the EGM. Following the user scanning the QR code with their mobile device, the mobile device is directed to a website where the nonce is validated and the user is prompted to provide various information regarding the ticket voucher to be redeemed, such as the amount of the ticket voucher, the ticket voucher validation number, and/or the date the ticket voucher was issued.

It should be appreciated that the ticket voucher related entries provided by the user enable the ticket voucher system to identify the ticket voucher as one to be securely validated in association with a transfer to a financial institution account. That is, by prompting the user to enter certain ticket voucher identifying information prior to presenting (e.g., inserting) the ticket voucher, the system is aware that a particular ticket voucher to be redeemed should not automatically be validated and redeemed in association with dispensing an amount of cash (if the gaming establishment device is a ticket voucher redemption kiosk) or increasing a credit balance (if the gaming establishment device is an EGM).

In certain embodiments, following the user entering one or more fields from the ticket voucher and the system updating transfer context data based on such fields, one or more components that operate an external funding service alert the ticket voucher system of the pending arrival of a ticket voucher to be transferred out to a financial institution account. Such alerts prepare the ticket voucher system with the appropriate transfer context for the upcoming redemption of a ticket voucher, such as by allotting more time for the transaction to be completed before timing out and returning the ticket voucher. For instance, as seen in FIG. 2A, the external funding service communicates a Be-On-The-Look-Out (“BOLO”) message to the ticket voucher system which records such a message in association with the ticket voucher to be redeemed. Such a BOLO message enables the ticket voucher system to anticipate the upcoming validation request on a ticket voucher such that, once received, the ticket voucher system designates that ticket voucher as pending an external account transfer. Such a designation causes the ticket voucher system to not return any amount of funds associated with the ticket voucher to the gaming establishment device. That is, to ensure that the value of the redeemed ticket voucher is not inadvertently transferred to the gaming establishment device and to further avoid triggering the above-described timeout procedure which certain gaming establishment devices invoke when redeeming a ticket voucher, the system prepares the ticket voucher system for an upcoming transaction in which funds from a ticket voucher are transferred to a financial institution account.

In certain embodiments, following the external funding service alerting the ticket voucher system of the pending arrival of a ticket voucher associated with a potential transfer of funds to a financial institution account and the user presenting (e.g., inserting) the ticket voucher, the system enables the user to continue providing information needed to complete the transaction by redirecting the user to a web page (or other interface) provided by a component of the payment gateway that enables the user to select and authenticate the external destination of the ticket voucher funds, and initiate the transfer. For example, the user engages with a mobile device application to select a funds destination to transfer the funds from the ticket voucher to and perform any authentication steps necessary with their funding destination, such as entering their debit card CVV code, and/or login to their bank.

In certain embodiments, following the user selecting and authenticating a destination for the amount of funds associated with the redeemed ticket voucher, the ticket voucher system operates with the external funding service (which operates with the payment gateway) to cause the amount of funds associated with the redeemed ticket voucher to be transferred to the user designated destination, such as the user's bank account. The ticket voucher system additionally updates the state of the ticket voucher to reflect that the ticket voucher has been redeemed in association with an external transfer of funds. For example, as seen in FIG. 2A, following the user designating (or previously designating in association with an initiation of the ticket voucher redemption) an external destination of the amount of funds associated with the ticket voucher, the payment gateway interacts with the external funding service to authorize the transfer, and the external funding service interacts with the ticket voucher system to complete, via the payment gateway, the transfer of funds associated with the ticket voucher from an account associated with the ticket voucher system to the user designated external destination. In this example, the transfer of funds from both the ticket voucher system to the external funding service and from the external funding service to the payment gateway each involve a two-phased commit transaction involving an authorize phase followed by a commit phase to complete the transaction. As further seen in FIG. 2A, following the redemption of the ticket voucher in association with such a transfer, the ticket voucher system modifies the state of the ticket voucher to reflect that the funds associated with the ticket voucher have been (or will be upon a subsequent settlement event) transferred to a financial institution account.

Accordingly, in certain embodiments, the responsive to a receipt, independent of any receipt of a ticket voucher by any electronic gaming machines, of data associated with a financial institution account redemption of the ticket voucher, the system designates, in a ticket voucher database, that ticket voucher as redeemable independent of transferring an amount of funds associated with the ticket voucher to any electronic gaming machines. In these embodiments, the system receives, from a mobile device, data associated with a financial institution account associated with a user. Additionally and following a receipt, by an electronic gaming machine, of the ticket voucher and a validation of the ticket voucher, the system causes the amount of funds associated with the ticket voucher to be transferred to the financial institution account.

In various embodiments, the system of the present disclosure includes or otherwise operates with various sub-systems to enable the redemption of a ticket voucher for a transfer of funds to an external account in association with escrowing funds to a gaming establishment account. In such embodiments, the system employs a wallet service that will escrow the funds from a redeemed ticket voucher and following such an escrow (and a user interacting with a payment gateway to provide information regarding a financial institution account destination of such funds as described above) the escrowed funds associated with the redeemed ticket voucher are transferred from a gaming establishment account to a financial institution account associated with the user. In these embodiments, to facilitate a redemption of a ticket voucher for a transfer of funds to a financial institution account, the system employs a gaming establishment device (e.g., a ticket voucher redemption kiosk, or an EGM), one or more components of a ticket voucher system, and one or more components of a gaming establishment fund management system that maintain one or more gaming establishment accounts and that interface with one or more components that maintain the financial institution account.

In certain embodiments, one or more components of the system (or otherwise operable with the system) are each associated with or otherwise maintain one or more electronic or virtual accounts. In these embodiments, the system employs such an account to escrow funds associated with a ticket voucher prior to the funds being transferred to a financial institution account. For example, as seen in FIG. 1B, a gaming establishment device (e.g., a ticket voucher redemption kiosk 120) is in communication with one or more servers operating a gaming establishment wallet service (i.e., wallet service 122). Such servers operating a gaming establishment wallet service are in communication with a payment gateway (i.e., banking gateway application 106) which, as described above, is in communication with a network of one or more banks or other financial institutions (i.e., the banking networks 108) that operate to electronically maintain funds in the user's accounts at such banks or other financial institutions.

In certain embodiments, the account employed to escrow funds associated with a redeemed ticket voucher prior to such funds being transferred to a financial institution account is associated with or otherwise maintained for a user. In these embodiments, the account comprises a cashless wagering account (e.g. a cashless wagering wallet, a cashless sports wagering wallet and/or a cashless mobile wagering wallet), a retail account (e.g., a retail wallet) and/or a user escrow account (e.g., a user escrow wallet) that the user may additionally access to transfer funds and/or view balance information amongst the various accounts associated with or otherwise maintained for the user. In certain other embodiments, the account employed to escrow funds is maintained independent of any identified user. In certain such embodiments, the system employs an anonymous gaming establishment escrow account for each user that undertakes transferring an amount of funds associated with a ticket voucher to a financial institution account. In certain other embodiments, the system employs a general gaming establishment escrow account (e.g., a gaming establishment escrow wallet) to facilitate the redemptions of ticket vouchers and the associated transfers of funds to financial institution accounts associated with users.

In various embodiments, following a user obtaining one or more ticket vouchers, such as upon a user of an EGM cashing out a credit balance in exchange for a ticket voucher associated with an amount of funds of the cashed out credit balance, the system enables a user to redeem the ticket voucher in exchange for a non-cash form of payment including a transfer of the amount of funds associated with the ticket voucher to a wallet service and then to a financial institution account. In certain such embodiments in which the gaming establishment device is a ticket voucher redemption device, prior to (or in association with) a user inserting a ticket voucher into the kiosk, the ticket voucher redemption kiosk prompts the user if they want to redeem a ticket voucher for cash or for a transfer of the funds associated with the ticket voucher to a financial institution account, such as a bank account.

In these embodiments, if the user selects a transfer to a financial institution account, the ticket voucher system causes the amount of funds associated with the ticket voucher to be escrowed in an account of a wallet system awaiting subsequent transfer. Following such an escrow of funds, as described above, the user is presented with a QR code that, when scanned, causes content associated with the payment gateway to be presented to the user, such as on the user's mobile device. Using functionality from the presented content, the user selects their financial institution and authenticates against their financial institution which informs the payment gateway of the user's financial institution account information (e.g., account number, routing number). Using the financial institution account information, the payment gateway acquires the escrowed funds from the wallet system and, using banking network protocols and functions, executes a transfer of the funds acquired from the wallet system to the user's financial institution account. For example, as seen in FIG. 2B (which illustrates the different interactions between a user with a mobile device, a ticket voucher redemption kiosk, a component of a ticket voucher system, a component of a wallet system, a component that executes a payment gateway and a banking network), following a user indicating that they want to transfer an amount of funds associated with an inserted ticket voucher to a bank account and following, as described in more detail below, any analysis of the redemption to comply with various gaming and non-gaming regulations, the ticket voucher system causes the amount of funds to be escrowed in a wallet maintained by a wallet system. As further seen in FIG. 2B, following a user interfacing, via their mobile device, with the payment gateway to authenticate their bank account, the payment gateway facilitates a transfer of the escrowed funds from the wallet system to the user's bank account via the banking network. Following the redemption of the ticket voucher in association with such a transfer, the ticket voucher system modifies the state of the ticket voucher to reflect that the funds associated with the ticket voucher have been (or will be upon a subsequent settlement event) transferred to a financial institution account.

Accordingly, in certain embodiments, responsive to a receipt, via a ticket voucher redemption kiosk, of data associated with a ticket voucher and responsive to a validation of the ticket voucher, the system escrows an amount of funds associated with the ticket voucher in a gaming establishment account. In these embodiments, responsive to a receipt of data associated with a financial institution account associated with a user, the system causes the amount of funds associated with the ticket voucher to be transferred from the gaming establishment account to the financial institution account.

It should be appreciated that while the example of FIG. 2B includes the employment of a wallet service, in certain other embodiments, the system enables a user to redeem the ticket voucher in exchange for a non-cash form of payment including a transfer of the amount of funds associated with the ticket voucher to a financial institution account independent of any wallet service. In such embodiments, the system operates independent of escrowing any amount of funds associated with the ticket voucher to an electronic wallet prior to transferring such funds to a financial institution account.

In certain embodiments, in association with a redemption of a ticket voucher in which funds associated with the ticket voucher are transferred, directly or indirectly, to a financial institution account, the gaming establishment device returns (i.e., does not stack the ticket voucher in a receptacle of a payment acceptor) the redeemed ticket voucher for potential dispute resolution purposes. In these embodiments, after the user inserts the ticket voucher into the gaming establishment device and the amount of the ticket voucher is prepped to be transferred to the financial institution account associated with the user, the payment acceptor of the gaming establishment device ejects the ticket voucher prior to the ticket voucher being stacked. In these embodiments, since such a transaction is mostly anonymous to the gaming establishment (i.e., the user identifies themselves to their financial institution but not the gaming establishment), in the case of errors during the transfer process, such a configuration is advantageous to enable the user to have a receipt of their actions (which the returned ticket voucher operates as).

In certain embodiments, in association with a redemption of a ticket voucher in which funds associated with the ticket voucher are transferred, directly or indirectly, to a financial institution account, the gaming establishment device retains (i.e., stacks the ticket voucher in a receptacle of a payment acceptor) the redeemed ticket voucher (which is then utilized by gaming establishment personnel in the soft-count collection and reconciliation of ticket vouchers). In certain such embodiments, since the ticket voucher is retained by the gaming establishment device, to aid the user in potential dispute resolution purposes, the system commands a printer of the gaming establishment device (or otherwise) to print a receipt for the user. Such a receipt has most (or all) of the ticket voucher data printed on it and can be used by the user while interacting with gaming establishment personnel to resolve any problems with the transfer of funds to the financial institution account.

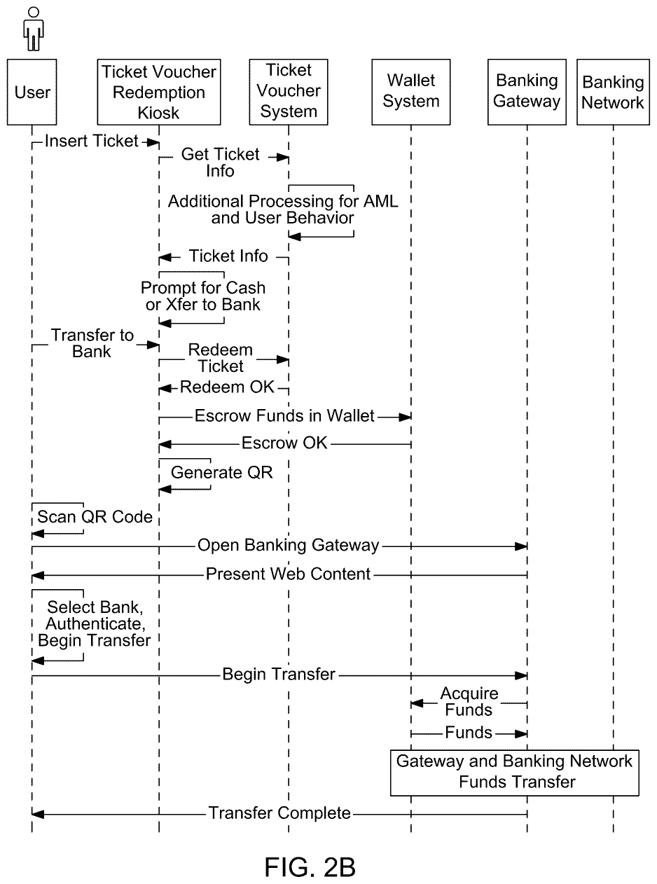

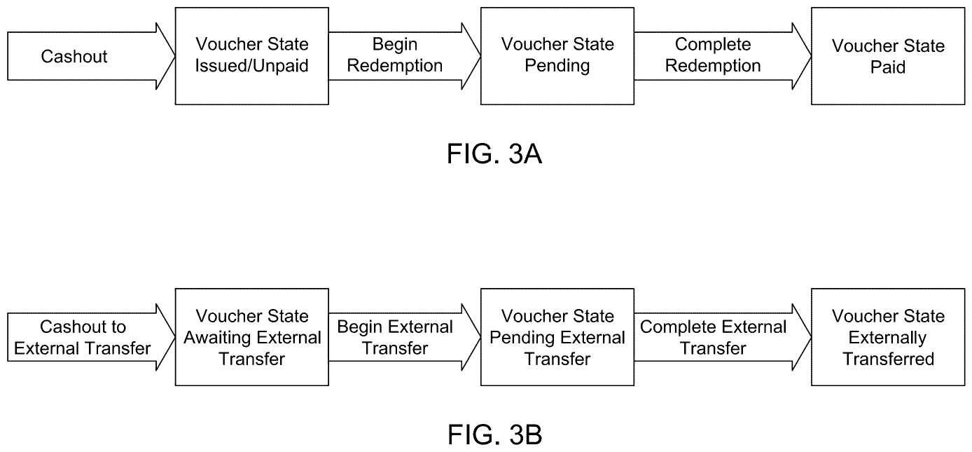

In certain embodiments, as mentioned above, the system employs one or more ticket voucher states to reflect that the funds of a ticket voucher have been redeemed in association with a transfer to a financial institution account. That is, to enable the proper tracking of ticket vouchers and specifically to place a ticket voucher in a state awaiting one or more components to transfer the value of the ticket voucher to a financial institution account, the system employs one or more ticket voucher states specific to external transfers to enable the relative quick and seamless identification of any ticket vouchers that will be/were redeemed as part of a transfer of funds to a financial institution account. In these embodiments, as a supplemental to a ticket voucher cycling, as seen in FIG. 3A, from being issued and associated with an unpaid state (in which the amount of funds associated with the ticket voucher can still be accessed) to a pending state (following the beginning of a redemption of that ticket voucher) to being redeemed and associated with a terminal paid state (in which the amount of funds associated with the ticket voucher are no longer accessible), as seen in FIG. 3B, following a user indicating that a ticket voucher will be redeemed in association with a transfer of funds to a financial institution account, the system employs the additional states of an awaiting external transfer state (in which, as described above, the user makes one or more inputs to ready the ticket voucher for external transfer), a pending external transfer state (following the beginning of a redemption of that ticket voucher in association with an external transfer) and a terminal externally transferred state (in which the amount of funds associated with the ticket voucher are no longer accessible). As such, to account for at least instances in which a ticket voucher redeemed for an external transfer is returned to a user as a receipt for the redemption (and thus not retained or stacked), such a configuration enables the system to properly track ticket voucher redemptions for accounting reconciliation and troubleshooting purposes.

Accordingly, in certain embodiments, the system maintains a ticket voucher database including data associated with a ticket voucher and responsive to a receipt, independent of any receipt of the ticket voucher by any gaming establishment devices, of data associated with an external redemption of the ticket voucher, associates, in the ticket voucher database, the ticket voucher with a first external transfer state. In these embodiments, following a receipt, by a gaming establishment device, of the ticket voucher and a determination to validate the ticket voucher, the system associates, in the ticket voucher database, the ticket voucher with a second, different external transfer state.

In certain such embodiments that facilitate the same ticket voucher having multiple avenues to redemption, the system maintains a ticket voucher database comprising data associated with a ticket voucher. Responsive to an authorized redemption of the ticket voucher in association with a transfer of an amount of funds associated with the ticket voucher to a balance of a gaming establishment device, the system associates, in the ticket voucher database, that ticket voucher with a first terminal voucher state. In such embodiments, responsive to an authorized redemption of the ticket voucher in association with a transfer of the amount of funds associated with the ticket voucher to a financial institution account, the system associates, in the ticket voucher database, that ticket voucher with a second, different terminal voucher state.

In certain embodiments, eligibility to redeem a ticket voucher in association with a transfer of funds to a financial institution account is based on one or more actions (and/or inactions) of a user (and/or other users). In these embodiments, different actions (and/or inactions) undertaken by the user factor into whether or not that ticket voucher is eligible to be redeemed in association with a transfer of associated funds to a financial institution account. In certain such embodiments, as described above, the eligibility is determined based on one or more inputs received by the user indicating they want to redeem a ticket voucher in association with a transfer of funds to a financial institution account. In certain other embodiments, the system enables a user to opt-out of (or alternatively opt-into) redeeming a ticket voucher in association with a transfer of funds to a financial institution account. In certain embodiments, the system enables a user to make one or more inputs, such as inputs via an externally controlled user interface displayed by an EGM (i.e., a service window) or via a mobile device linked to the device, to opt-out (or alternatively opt-into) redeeming a ticket voucher in association with a transfer of funds to a financial institution account. In certain embodiments, the system enables a user to associate an opt-out (or opt-in) selection with an account maintained for the user, such as a player tracking account, such that following the user making the selection once, the selection applies to future ticket voucher redemptions in which the user logs into their account from a gaming establishment device.

In certain embodiments, in providing the option of redeeming a ticket voucher for a transfer of funds to a financial institution account, the system employs one or more safeguards to ensure that any transfer of funds associated with any ticket vouchers to any financial institution accounts correspond with gaming establishment regulations, financial institution regulations and/or user preferences. In certain such embodiments, the system employs one or more anti-money laundering services to ensure that such transfers comply with various anti-money laundering obligations (e.g., anti-money laundering regulations) which require the tracking of certain financial transactions associated with a gaming establishment patron. In these embodiments, since the ticket vouchers are anonymous instruments and are effectively bearer bonds for the user and the gaming establishment, the system augments one or more external fund transfers with anti-money laundering capabilities.

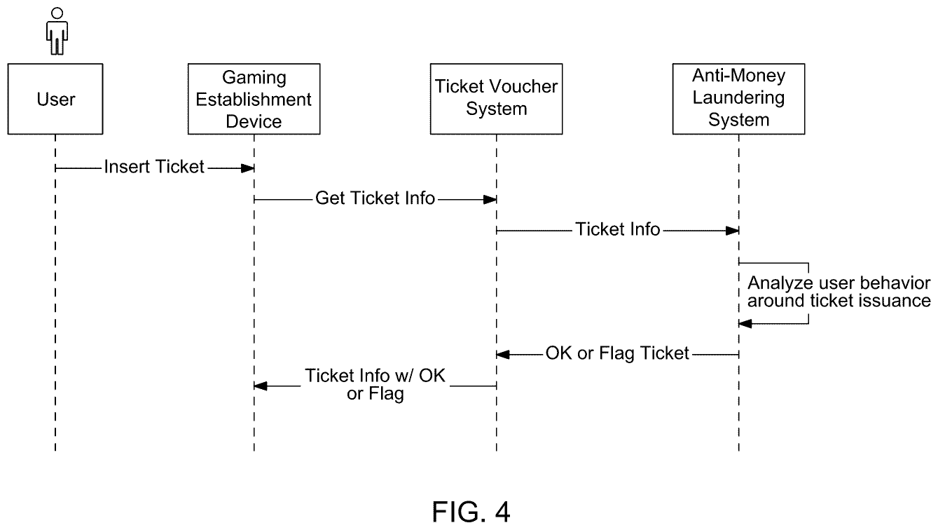

In certain embodiments employing anti-money laundering capabilities, the system will query the ticket voucher system and/or an anti-money laundering system (e.g., anti-money laundering service 124 of FIG. 1B) for supplemental information associated with the ticket voucher, such as behavior of the user associated with the redemption of the ticket voucher, and/or gaming session information (e.g., how many games were played, how the money got into the gaming establishment device, if the money cashed out was actually played/wagered since it was deposited onto the gaming establishment device) associated with acquiring the ticket voucher. In these embodiments, the system employs such supplemental information to determine if the ticket voucher is eligible to be redeemed in association with a transfer of funds to a financial institution account. For example, as seen in FIG. 4 (which illustrates the different interactions between a user, a gaming establishment device, a component of a ticket voucher system, and a component of a anti-money laundering system), following a user inserting a ticket voucher into a gaming establishment device, the ticket voucher system retrieves ticket voucher information and forwards such ticket voucher information to an anti-money laundering system. In this example, the anti-money laundering system operates to analyze the user's behavior associated with the issuance of the ticket voucher and determines whether or not to permit that ticket voucher to be redeemed in association with a transfer of ticket voucher funds to a financial institution account. As illustrated by this example, in certain embodiments, responsive to a redemption, at a gaming establishment device, of a ticker voucher associated with a request to transfer an amount of the ticket voucher to a financial institution account associated with a user, the system determines if the redemption of the ticket voucher complies with a gaming establishment anti-money laundering obligation. Responsive to the determination being that the redemption of the ticket voucher complies with the gaming establishment anti-money laundering obligation, the system causes the amount of funds associated with the ticket voucher to be transferred to the financial institution account. On the other hand, responsive to the determination being that the redemption of the ticket voucher does not comply with the gaming establishment anti-money laundering obligation, the system disables the amount of funds associated with the ticket voucher from being transferred to the financial institution account.

In certain embodiments, based on the analysis associated with the issuance of the ticket voucher, the system may impose one or more limits on the user's ability to redeem ticket vouchers for transfers to financial institution accounts. That is, the system adjusts how it operates to limit or restrict redemption of the ticket voucher based on the information reported by the anti-money laundering system (and/or other system tasked with monitoring user activities). Accordingly, in certain embodiments, responsive to a redemption of a ticker voucher associated with a request to transfer an amount of the ticket voucher to a financial institution account associated with a user, the system determines if the redemption of the ticket voucher complies with a transfer limit. Responsive to the determination being that the redemption of the ticket voucher complies with the transfer limit, the system causes the amount of funds associated with the ticket voucher to be transferred to the financial institution account. On the other hand, responsive to the determination being that the redemption of the ticket voucher does not comply with the transfer limit, the system disables the amount of funds associated with the ticket voucher from being transferred to the financial institution account.

In certain embodiments, the system adjusts how it operates by employing the same limits or restrictions for all users. In certain other embodiments, the system adjusts how it operates by employing different limits or restrictions for different users. That is, the system associates different users with different limitations in redeeming a ticket voucher in association with a transfer of funds to a financial institution account. In certain such embodiments, the system limits the number of transfers to financial institution accounts based on one or more attributes or preferences of a user. In certain such embodiments, the system employs an identity of the user in determining any limitations to impose. In these embodiments in which the user is an anonymous user, the system limits the user to transferring a first amount per period of time (e.g., $500 per day) to a single financial institution account (e.g., a single bank account, a single credit card account, a single debit card account or a single pre-paid card account) associated with that user. On the other hand, if the user is known (e.g., identified by a player tracking account) but is not associated with a gaming establishment fund management system account (e.g., a cashless wagering account), the system limits the user to transferring a second amount per period of time (e.g., $1500 per day) to a single financial institution account associated with that user. In these embodiments, the system applies the limit on a per external account basis.

In certain embodiments, the system applies one or more limits as a total limit for all financial institution accounts associated with that user. For example, if a user is an anonymous user, the system limits the user to transferring a first amount per period of time to all financial institution accounts associated with that user and if the user is a known user, the system limits the user to transferring a second amount per period of time to all financial institution accounts associated with that user. In different embodiments, the limitation to associate with a user is based on one or more additional or alternative attributes associated with the user such as, but not limited to, wagering history of that user, non-wagering history of that user, whether or not the user has an account with a gaming establishment management system (e.g., a player tracking account maintained by a patron management system), a ranking of any account the user has with the gaming establishment management system (e.g., users of a certain player tracking status, such as gold level users, are eligible to redeem a ticket voucher in association with a transfer of funds to an external account while users of a different player tracking status, such as bronze level users, are ineligible), an age of the user (detectable by a camera of the gaming establishment device of the user and/or an age verification procedure associated with one or more accounts of the user), and/or a location of the user.

In certain embodiments, the system limits the amount of an external transfer based on ticket voucher redemption history. In certain such embodiments, during the process of redeeming an amount of a ticket voucher to a financial institution account, the system determines that the user has redeemed too many ticket vouchers to the financial institution account during a current period of time and limits subsequent ticket voucher redemptions to the financial institution account. For example, if the system determines that the user has redeemed too many ticket vouchers to one or more financial institution accounts over the past 24 hours, the system places a limit on subsequent redemptions to such financial institution accounts and causes the gaming establishment device (and/or the user's mobile device) to inform the user that they have hit their redemption limit for the day and that they must try again during the next period of time (e.g., tomorrow).

In certain embodiments, the system limits the number of transfers involving the redemption of ticket vouchers based on information associated with the ticket voucher. In these embodiments, during the process of redeeming an amount of a ticket voucher to a financial institution account, the system determines one or more attributes of the ticket voucher and utilizes such attributes in determining whether or not to permit a redemption of the amount of the ticket voucher to a financial institution account. In other words, responsive to an attempted transfer of funds to a financial institution account via the redemption of a ticket voucher obtained at the conclusion of a gaming session, the system reviews (and/or triggers gaming establishment personnel to review) gaming session information to determine that the user has played as expected and the procurement of the ticket voucher does not have any characteristics indicative of an attempt to launder money. In such embodiments, if the ticket voucher was obtained following a gaming session at an EGM, the system analyses certain gaming session information (e.g., how many games were played, how the money got into the gaming establishment device, if the money cashed out was actually played/wagered since it was deposited onto the gaming establishment device) associated with acquiring the ticket voucher and employs such information in determining whether or not to permit a redemption of the amount of the ticket voucher to a financial institution account. In such embodiments, if the ticket voucher was obtained independent of any gaming session at an EGM (e.g., a ticket voucher obtained by a user exchanging money for the ticket voucher), the system analyses certain non-gaming session information (e.g., how much is the ticket voucher, how may similar transactions have occurred in association with the gaming establishment account) and employs such information in determining whether or not to permit a redemption of the amount of the ticket voucher to a financial institution account.

In certain embodiments, the system employs one or more limitations on ticket voucher redemptions, such as imposing upper limits and/or lower limits on transfers of funds to a financial institution account associated with a redeemed ticket voucher. In certain such embodiments, the system imposes limits based on one or more aspects associated with the acquisition of a ticket voucher. For example, the system limits the financial institution account ticket redemption option to being available to users that are playing high credit denomination EGMs. In this example, a user not playing high credit denomination EGMs may overcome this limitation by presenting their government issued identification to a member of gaming establishment personnel or otherwise obtaining approval by gaming establishment personnel.

In certain embodiments, the system employs one or more responsible gaming services to ensure that any transfers of funds to a financial institution account associated with a redeemed ticket voucher comply with responsible gaming limitations on users (due to jurisdictional requirements, user self-imposed requests and/or gaming establishment-imposed requests). In these embodiments, the system modifies one or more fund transfers to a financial institution account based on such responsible gaming limitations. In one such embodiment, if a user requests a “cooling off” period after transferring funds to a financial institution account via the redemption of a ticket voucher, the system will not complete the transfer to the financial institution account until the “cooling off” period has completed. For example, if the user is flagged as a gambler who has hit their self-imposed spending limit for the day (or a limit imposed by the jurisdiction), the system enables the redemption of the ticket voucher with the modification that the electronic transfer of the funds represented by the ticket voucher will be escrowed for 24 hours before being deposited into the user's designated bank account. Such a delayed transfer completion operates as a deterrent to the user from using those funds at other gaming establishments and encourages the user to take a break from wagering activities. In certain embodiments in which the user is anonymous, the responsible gaming limitation applies per financial institution account. In certain embodiments in which the user is known (e.g., identified by a player tracking account) but is not associated with a gaming establishment fund management system account (e.g., a cashless wagering account), the responsible gaming limitation applies at the user level and operates against transfers to all financial institution accounts for the cooling off period of time.

It should be appreciated that these limitations on transfers of funds to a financial institution account in association with a redemption of a ticket voucher may be imposed individually or collectively. For example, in instances in which minimum limits or thresholds are imposed by jurisdictional regulations, a user's self-imposed responsible gaming limited operates to impose a stricter limitation than the jurisdictionally mandated limitation.

In certain embodiments, if the system determines that a limitation or restriction is reached, the system prohibits subsequent redemptions of ticket vouchers to a financial institution account until the limitation or restriction is resolved (either through the passage of time or being reset upon gaming establishment personnel involvement). In one such embodiment, the gaming establishment device disables redemption of the ticket voucher based upon the information reported and informs the user to proceed to a gaming establishment interface, such as a casino cage.

In another embodiment, the gaming establishment device enters a tilt or lock up state until gaming establishment personnel engage the gaming establishment device to evaluate the transaction and/or obtain identification of the user, such as a driver's license or other government issued identification. In another embodiment, the gaming establishment device triggers gaming establishment personnel involvement to determine how to proceed with the transaction, such as requiring approval to proceed with the transaction following gaming establishment personnel validating that the user is not on one or more list (e.g., a politically exposed person list) that would prevent or block the electronic transfer of funds. As such, in certain embodiments, responsive to a redemption, at a gaming establishment device, of a ticker voucher associated with a request to transfer an amount of the ticket voucher to a financial institution account associated with a user, the system determines if the redemption of the ticket voucher complies with a gaming establishment anti-money laundering obligation. In these embodiments, responsive to the determination being that the redemption of the ticket voucher complies with the gaming establishment anti-money laundering obligation, the system causes the amount of funds associated with the ticket voucher to be transferred, via a payment gateway of a gaming establishment fund management system, to a financial institution account. On the other hand, responsive to the determination being that the redemption of the ticket voucher does not comply with the gaming establishment anti-money laundering obligation, the system alerts gaming establishment personnel to the gaming establishment device.

In another embodiment, the gaming establishment device and/or web page (or other interface) accessed by the mobile device may give the user another option to bypass the imposed limit by enabling the user to scan a picture of their government issued identification (and/or performing any required additional steps, such as performing a liveliness test where they take a selfie to prove they are alive). In these embodiments, performing these actions could result in the system modifying certain of the imposed limits such as providing the user a larger daily transfer limit to one or more financial institution accounts.

In certain embodiments, since certain fees are imposed by a financial institution on the movement of funds to/from a financial institution account maintained by the financial institution, the system operates to refund to a user part or all of such imposed fees. In certain embodiments, in association with the movement of funds from the ticket voucher system to a financial institution account in association with a redemption of a ticket voucher, the system tracks certain activities occurring in association with a ticket voucher and determines whether to trigger a refund of part or all of the fees incurred to move the funds to the financial institution account. In these embodiments, in view of certain financial institution accounts being associated with a fee amount charged to complete a transfer of funds involving such financial institution accounts and in view of certain users forgoing the transfer of funds because of these imposed fees, responsive to a determination that one or more activities or situations warrant a refund eligibility, the system provides part or all of such imposed fees to the user.

In certain such embodiments, based on zero, one or more events occurring (or not occurring) in association with the procurement of the ticket voucher (e.g., an amount of wagers placed during a gaming session which the ticket voucher resulted from, and/or whether the user whom obtained the ticket voucher identified themselves prior to or during the gaming session), the system determines whether or not to provide a user a partial or full refund of fees incurred in association with the transfer and if so, determines a form of the refund (e.g., cashable credits or non-cashable credits). In certain additional or alternative embodiments, based on zero, one or more events occurring (or not occurring) separate from the procurement of the ticket voucher (e.g., any gaming establishment patron management system ranking of the user whom redeemed the ticket voucher, any historical wagering activity of the user tracked by the gaming establishment, gaming establishment personnel deciding to waive fees on a per transfer basis and/or a user presenting a transaction receipt from a financial institution to gaming establishment personnel and requesting a refund of fees for such a transaction), the system determines whether or not to provide a user a partial or full refund of fees incurred in association with the transfer and if so, determines a form of the refund (e.g., cashable credits or non-cashable credits). Such a refund effectively minimizes (or eliminates) the impact of such fees and encourages the transfer of funds from a ticket voucher system to one or more financial institution accounts.

In certain embodiments, to incentive users to redeem ticket vouchers in association with financial institution accounts, the system offers certain promotions, such as limited time bonus events, in association with such redemptions. In these embodiments, given the difficulty of offering promotions to anonymous users, the system employs the redeemed ticket vouchers to offer such promotions. In certain such embodiments, in association with a user redeeming a ticket voucher in association with a transfer of associated fund to a financial institution account, the system determines any bonus events (e.g., static awards, variable awards, plays of games to potential win awards) to associate with that ticket voucher. In such embodiments, the system determines whether or not to associate any bonus events (or potential bonus events) with the ticket voucher based on certain factors associated with obtaining the ticket voucher and/or redeeming the ticket voucher. In different embodiments, based on one or more factors, including, but not limited to, an amount of funds associated with the ticket voucher, an identity of a holder of the ticket voucher, the gaming establishment device that the ticket voucher is being issued from and/or a satisfaction of one or more conditions, the system determines whether or not to associate a bonus event (or a potential bonus event) with the redeemed ticket voucher. For example, following a determination that an unidentified user at an EGM procured a ticket voucher following a relatively negative experience at the EGM (e.g., the player has cashed out a credit balance of the EGM to a ticket voucher after losing at least a threshold quantity of games in a row), when that ticket voucher is subsequently redeemed in association with a transfer of funds to a financial institution account, the system determines to associate a bonus event with the redeemed ticket voucher. In certain such embodiments, the system associates the bonus event with the redeemed ticket voucher and returns the ticket voucher to the user. In these embodiments, the returned ticket voucher is then redeemable for the associated bonus event. In certain additional or alternative embodiments, the system associates the bonus event with the redeemed ticket voucher and communicates data associated with the associated bonus event to a mobile device of the user. In certain additional or alternative embodiments, the system associates the bonus event with the redeemed ticket voucher and informs that the user that the associated bonus event is awaiting them if they sign up for a gaming establishment patron management system account, such as a player tracking account.

It should be appreciated that in addition to potentially providing a relatively more secure environment for a user (via reducing or eliminating a user carrying cash on their person after redeeming a ticket voucher and thus diminishing the risks that such cash may be lost or stolen), the system benefits the gaming establishment by freeing the gaming establishment up from having to maintain relatively large amounts of cash in any cash dispensing kiosks. By reducing the use of such kiosks by enabling users to cash their ticket voucher to a financial institution account from any gaming establishment device, the system enables gaming establishments to maintain less amounts of cash in kiosks, reduces the wear and tear on such devices (thus prolonging the operational life on these devices) and may even require fewer cash dispensing kiosks (thus reducing energy consumption by the casino). Moreover, a reduction in cash-based transactions reduces computational resources otherwise dedicated to sorting, counting and processing such cash, leading to energy savings as components tasked with sorting, counting and processing such cash are used less.

Additionally, by reducing the amount of cash transactions in a gaming establishment via redeeming ticket vouchers for financial institution account transfers, the system reduces or eliminates human errors which often occur when ticket vouchers are redeemed at gaming establishment interfaces, such as casino desks. Specifically, eliminating gaming establishment personnel from issuing amounts of cash in exchange for redeemed ticket vouchers not only protects the user (if the gaming establishment personnel provides the gaming establishment patron less cash than the patron deserves) but also protects the gaming establishment (if the gaming establishment personnel inadvertently or fraudulently provides the patron more cash than the patron deserves). As such, to further expand the cashless ecosystem certain gaming establishments strive for and since certain gaming establishment patrons are uncomfortable with large amounts of cash in a gaming establishment, the system of the present disclosure realizes various advantages not available from prior systems by enabling a user the opportunity to redeem a ticket voucher for an amount of funds transferred to a financial institution account in which the redemption occurs independent of any amount of cash and relatively more secure than any transaction involving an amount of cash.

It should be appreciated that any functionality or process of the present disclosure may be implemented via one or more components of a gaming establishment system (e.g., a server of a ticket voucher system, a server of an external funding service, a server of a payment gateway, a server of a wallet system, a server of an anti-money laundering system and/or a server of a responsible gaming system), one or more gaming establishment devices (e.g., a gaming device such as an EGM or a non-gaming device such as a ticket voucher redemption kiosk), one or more components associated with a gaming establishment device (such as a SMIB or other component of a gaming establishment management system supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device, such functions, features or processes may alternatively be performed by one or more components associated with the gaming establishment device, one or more components of a gaming establishment system, or one or more mobile device applications, (ii) while certain functions, features or processes are described herein as being performed by a component associated with a gaming establishment device, such functions, features or processes may alternatively be performed by one or more gaming establishment devices, one or more components of a gaming establishment system, or one or more mobile device applications, (iii) while certain functions, features or processes are described herein as being performed by one or more mobile device applications, such functions, features or processes may alternatively be performed by one or more components of a gaming establishment system, one or more gaming establishment devices, or one or more components associated with a gaming establishment device, and/or (iv) while certain functions, features or processes are described herein as being performed by one or more components of a gaming establishment system, such functions, features or processes may alternatively be performed by one or more gaming establishment devices, one or more components associated with a gaming establishment device, or one or more mobile device applications.

In certain embodiments, the above-described embodiments of the present disclosure may be implemented in accordance with or in conjunction with zero, one or more gaming establishment devices (e.g., an EGM, or a ticket voucher redemption kiosk); zero, one or more components associated with a gaming establishment device (e.g., a SMIB associated with an EGM) and/or zero, one or more components of a gaming establishment system (e.g., a server of a ticket voucher system, a server of an external funding service, a server of a payment gateway, a server of a wallet system, a server of an anti-money laundering system and/or a server of a responsible gaming system). In these embodiments, such devices and components each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the gaming establishment device, the component associated with the gaming establishment device, and/or the component of the gaming establishment system; (3) accessing memory to configure or reconfigure parameters in the memory according to indicia read from the gaming establishment device, the component associated with the gaming establishment device, and/or the component of the gaming establishment system; (4) communicating with interfaces and the peripheral devices (such as input/output devices); and/or (5) controlling the peripheral devices. In certain embodiments, one or more components of the controller (such as the at least one processor) reside within a housing of the gaming establishment device, the component associated with the gaming establishment device, and/or the component of the gaming establishment system, while in other embodiments, at least one component of the controller resides outside of the housing of the gaming establishment device, the component associated with the gaming establishment device, and/or the component of the gaming establishment system.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the gaming establishment device, the component associated with the gaming establishment device, and/or the component of the gaming establishment system. In certain embodiments, the at least one memory device resides within the housing of the gaming establishment device, the component associated with the gaming establishment device, and/or the component of the gaming establishment system, while in other embodiments at least one component of the at least one memory device resides outside of the housing of the gaming establishment device, the component associated with the gaming establishment device, and/or the component of the gaming establishment system. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the gaming establishment device, the component associated with the gaming establishment device, and/or the component of the gaming establishment system; (2) associations between configuration indicia read from the gaming establishment device, the component associated with the gaming establishment device, and/or the component of the gaming establishment system with one or more parameters and settings; (3) communication protocols configured to enable the at least one processor to communicate with the peripheral devices; and/or (4) communication transport protocols (such as TCP/IP, USB, Firewire, IEEE 1394, Bluetooth, IEEE 802.11x (IEEE 802.11 standards), hiperlan/2, HomeRF, etc.) configured to enable the gaming establishment device, the component associated with the gaming establishment device, and/or the component of the gaming establishment system to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the gaming establishment device, the component associated with the gaming establishment device, and/or the component of the gaming establishment system to control the gaming establishment device, the component associated with the gaming establishment device, and/or the component of the gaming establishment system. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user employs such a removable memory device in a component of the gaming establishment system to implement at least part of the present disclosure. In other embodiments, part or all of the program code and/or the operating data is downloaded to the at least one memory device of the gaming establishment device, the component associated with the gaming establishment device, and/or the component of the gaming establishment system through any suitable data network described above (such as an Internet or intranet).

The at least one memory device also stores a plurality of device drivers. Examples of different types of device drivers include device drivers for the gaming establishment device, the component associated with the gaming establishment device, and/or the component of the gaming establishment system and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the gaming establishment device, the component associated with the gaming establishment device, and/or the component of the gaming establishment system. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the gaming establishment device, the component associated with the gaming establishment device, and/or the component of the gaming establishment system loads the new device driver from the at least one memory device to enable communication with the new device. For instance, one type of card reader in the gaming establishment device, the component associated with the gaming establishment device, and/or the component of the gaming establishment system can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the gaming establishment device, the component associated with the gaming establishment device, and/or the component of the gaming establishment system and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the gaming establishment device, the component associated with the gaming establishment device, and/or the component of the gaming establishment system. In various embodiments, the display devices serve as digital glass configured to aspects of the gaming establishment in which the gaming establishment device, the component associated with the gaming establishment device, and/or the component of the gaming establishment system is located. In various embodiments, the gaming establishment device, the component associated with the gaming establishment device, and/or the component of the gaming establishment system includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the gaming establishment device, the component associated with the gaming establishment device, and/or the component of the gaming establishment system receives an actuation, the gaming establishment device, the component associated with the gaming establishment device, and/or the component of the gaming establishment system causes the payout device to provide a payment to the user. In certain embodiments, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the gaming establishment device, the component associated with the gaming establishment device, and/or the component of the gaming establishment system provides dynamic sounds coupled with attractive multimedia images displayed on one or more of the display devices to provide an audio-visual representation or to otherwise display full-motion video with sound to attract users to the gaming establishment device, the component associated with the gaming establishment device, and/or the component of the gaming establishment system. In certain embodiments, the gaming establishment device, the component associated with the gaming establishment device, and/or the component of the gaming establishment system displays a sequence of audio and/or visual attraction messages during idle periods to attract potential users to the gaming establishment device, the component associated with the gaming establishment device, and/or the component of the gaming establishment system. The videos may be customized to provide any appropriate information.

The at least one input device may include any suitable device that enables an input signal to be produced and received by the at least one processor of the gaming establishment device, the component associated with the gaming establishment device, and/or the component of the gaming establishment system. In one embodiment, the at least one input device includes a payment device configured to communicate with the at least one processor of the gaming establishment device, the component associated with the gaming establishment device, and/or the component of the gaming establishment system to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the gaming establishment device, the component associated with the gaming establishment device, and/or the component of the gaming establishment system operator to, when actuated, cause the gaming establishment device, the component associated with the gaming establishment device, and/or the component of the gaming establishment system to perform particular functions. For instance, such buttons may be hard keys, programmable soft keys, or icons icon displayed on a display device of the gaming establishment device, the component associated with the gaming establishment device, and/or the component of the gaming establishment system that are actuatable via a touch screen of the gaming establishment device, the component associated with the gaming establishment device, and/or the component of the gaming establishment system or via use of a suitable input device of the gaming establishment device, the component associated with the gaming establishment device, and/or the component of the gaming establishment system. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device, the component associated with the gaming establishment device, and/or the component of the gaming establishment system by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the gaming establishment device, the component associated with the gaming establishment device, and/or the component of the gaming establishment system. In one embodiment, a user input device docking region is provided, and includes a power distribution component that is configured to recharge a user input device without requiring metal-to-metal contact. In one embodiment, the at least one power distribution component is configured to distribute power to one or more internal components of the gaming establishment device, the component associated with the gaming establishment device, and/or the component of the gaming establishment system, such as one or more rechargeable power sources (e.g., rechargeable batteries) located at the gaming establishment device, the component associated with the gaming establishment device, and/or the component of the gaming establishment system.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the gaming establishment device, the component associated with the gaming establishment device, and/or the component of the gaming establishment system; detecting the presence and/or identity of various persons (e.g., users, casino employees, etc.), devices (e.g., user input devices), and/or systems within a predetermined proximity to the gaming establishment device, the component associated with the gaming establishment device, and/or the component of the gaming establishment system.

The at least one data preservation component is configured to detect or sense one or more events and/or conditions that, for example, may result in damage to the gaming establishment device, the component associated with the gaming establishment device, and/or the component of the gaming establishment system and/or that may result in loss of information associated with the gaming establishment device, the component associated with the gaming establishment device, and/or the component of the gaming establishment system. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the gaming establishment device, the component associated with the gaming establishment device, and/or the component of the gaming establishment system to operate in a mobile environment.

The at least one geolocation module is configured to acquire geolocation information from one or more remote sources and use the acquired geolocation information to determine information relating to a relative and/or absolute position of the gaming establishment device, the component associated with the gaming establishment device, and/or the component of the gaming establishment system. For example, in one implementation, the at least one geolocation module is configured to receive GPS signal information for use in determining the position or location of the gaming establishment device, the component associated with the gaming establishment device, and/or the component of the gaming establishment system. In another implementation, the at least one geolocation module is configured to receive multiple wireless signals from multiple remote devices (e.g., the gaming establishment device, the component associated with the gaming establishment device, and/or the component of the gaming establishment system, wireless access points, etc.) and use the signal information to compute position/location information relating to the position or location of the gaming establishment device, the component associated with the gaming establishment device, and/or the component of the gaming establishment system.

The at least one user identification module is configured to determine the identity of the current user or current owner of the gaming establishment device, the component associated with the gaming establishment device, and/or the component of the gaming establishment system. For example, in one embodiment, the current user is required to perform a login process at the gaming establishment device, the component associated with the gaming establishment device, and/or the component of the gaming establishment system in order to access one or more features. Alternatively, the gaming establishment device, the component associated with the gaming establishment device, and/or the component of the gaming establishment system is configured to automatically determine the identity of the current user based on one or more external signals, such as an RFID tag or badge worn by the current user and that provides a wireless signal to the gaming establishment device, the component associated with the gaming establishment device, and/or the component of the gaming establishment system that is used to determine the identity of the current user. In at least one embodiment, various security features are incorporated into the gaming establishment device, the component associated with the gaming establishment device, and/or the component of the gaming establishment system to prevent unauthorized users from accessing confidential or sensitive information.

The at least one information filtering module is configured to perform filtering (e.g., based on specified criteria) of selected information to be displayed at one or more displays of the gaming establishment device, the component associated with the gaming establishment device, and/or the component of the gaming establishment system.

In various embodiments, the gaming establishment device, the component associated with the gaming establishment device, and/or the component of the gaming establishment system includes a plurality of communication ports configured to enable the at least one processor of the gaming establishment device, the component associated with the gaming establishment device, and/or the component of the gaming establishment system to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the gaming establishment device, the component associated with the gaming establishment device, and/or the component of the gaming establishment system has a support structure, housing, or cabinet that provides support for a plurality of the input devices and the output devices of the gaming establishment device, the component associated with the gaming establishment device, and/or the component of the gaming establishment system.

It should be appreciated that in certain instances in which the gaming establishment device is an EGM, such an EGM includes certain components and/or are configured to operate in certain manners that differentiate these systems from general purpose computing devices. For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

It should be further appreciated that while one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor (i.e., a master gaming controller) running instructions to provide the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
responsive to a redemption of a ticker voucher associated with a request to transfer an amount of the ticket voucher to a financial institution account associated with a user, determine if the redemption of the ticket voucher complies with a transfer limit,
responsive to the determination being that the redemption of the ticket voucher complies with the transfer limit, cause the amount of funds associated with the ticket voucher to be transferred to the financial institution account, and
responsive to the determination being that the redemption of the ticket voucher does not comply with the transfer limit, disable the amount of funds associated with the ticket voucher from being transferred to the financial institution account.

2. The system of claim 1, wherein the transfer limit is associated with the user.

3. The system of claim 2, wherein the transfer limit comprises a responsible gaming limit.

4. The system of claim 1, wherein the transfer limit is associated with the financial institution account.

5. The system of claim 4, wherein the transfer limit is associated with an anti-money laundering regulation.

6. The system of claim 1, wherein the transfer limit is based on a gaming establishment device associated with the redemption of the ticker voucher.

7. The system of claim 1, wherein the memory device stores a plurality of further instructions that, when executed by the processor responsive to the determination being that the redemption of the ticket voucher does not comply with the transfer limit, cause the processor to cause the ticket voucher to be returned to the user.

8. The system of claim 1, wherein responsive to the determination being that the redemption of the ticket voucher does not comply with the transfer limit, the ticket voucher remains redeemable independent of the financial institution account.

9. The system of claim 1, wherein the memory device stores a plurality of further instructions that, when executed by the processor responsive to the determination being that the redemption of the ticket voucher does not comply with the transfer limit, cause the processor to designate, in a ticket voucher database, a predefined period of time until the amount of funds associated with the ticket voucher is transferrable to any gaming establishment devices.

10. A system comprising:
a processor; and
a memory device that stores a plurality of instructions that, when executed by the processor responsive to receipt of a ticket voucher to be redeemed independent of transferring an amount of funds associated with the ticket voucher to any electronic gaming machines, cause the processor to:
responsive to the ticket voucher complying with a transfer limit, cause the amount of funds associated with the ticket voucher to be transferred, via a payment gateway of a gaming establishment fund management system, to a financial institution account, and
responsive to the ticket voucher not complying with the transfer limit:
escrow the amount of funds associated with the ticket voucher for a predefined period of time, and
following the predefined period of time, cause the amount of funds associated with the ticket voucher to be transferred, via the payment gateway of the gaming establishment fund management system, to the financial institution account.

11. The system of claim 10, wherein the transfer limit comprises a responsible gaming limit.

12. A method of operating a system, the method comprising:
responsive to a redemption of a ticker voucher associated with a request to transfer an amount of the ticket voucher to a financial institution account associated with a user, determining, by a processor, if the redemption of the ticket voucher complies with a transfer limit,
responsive to the determination being that the redemption of the ticket voucher complies with the transfer limit, causing, by the processor, the amount of funds associated with the ticket voucher to be transferred to the financial institution account, and
responsive to the determination being that the redemption of the ticket voucher does not comply with the transfer limit, disabling, by the processor, the amount of funds associated with the ticket voucher from being transferred to the financial institution account.

13. The method of claim 12, wherein the transfer limit is associated with the user.

14. The method of claim 13, wherein the transfer limit comprises a responsible gaming limit.

15. The method of claim 12, wherein the transfer limit is associated with the financial institution account.

16. The method of claim 15, wherein the transfer limit is associated with an anti-money laundering regulation.

17. The method of claim 12, wherein the transfer limit is based on a gaming establishment device associated with the redemption of the ticker voucher.

18. The method of claim 12, further comprising, responsive to the determination being that the redemption of the ticket voucher does not comply with the transfer limit, causing, by the processor, the ticket voucher to be returned to the user.

19. The method of claim 12, wherein responsive to the determination being that the redemption of the ticket voucher does not comply with the transfer limit, the ticket voucher remains redeemable independent of the financial institution account.

20. The method of claim 12, further comprising, responsive to the determination being that the redemption of the ticket voucher does not comply with the transfer limit, designating, by the processor and in a ticket voucher database, a predefined period of time until the amount of funds associated with the ticket voucher is transferrable to any gaming establishment devices.
